(19) United States
(12) Patent Application Publication
(10) Pub. No.: US 2026/0023526 A1
(43) Pub. Date: Jan. 22, 2026

(54) SOCS AND METHODS FOR DATA STORAGE THEREOF

(71) Applicant: ICLEGEND MICRO (NANJING) CO., LTD., Nanjing (CN)

(72) Inventors: Deli KONG, Nanjing (CN); Ya SHI, Nanjing (CN)

(73) Assignee: ICLEGEND MICRO (NANJING) CO., LTD., Nanjing, Jiangsu (CN)

(21) Appl. No.: 19/345,190

(22) Filed: Sep. 30, 2025

Related U.S. Application Data
(63) Continuation-in-part of application No. PCT/CN2024/085836, filed on Apr. 3, 2024.

(30) Foreign Application Priority Data
Apr. 6, 2023 (CN) 202310363526.5

(51) Int. Cl. G06F 5/06; G06F 11/07; G06F 15/78

(52) U.S. Cl. CPC G06F 5/06; G06F 11/0772; G06F 15/7807

(57) ABSTRACT

Disclosed is a SOC and a method for data storage thereof. The SOC includes a storage module that is controllably and dynamically switchable between a first storage mode and a second storage mode, and a processing module. In the first storage mode, data in the storage module is accessible by the processing module in a first-in-first-out order; and in the second storage mode, data in the storage module is addressably accessible by the processing module. The embodiment of the present disclosure fully utilizes RAM resources of FIFO to act as a SOC memory, and achieves time-sharing multiplexing of RAM to realize that, for a batch transmission scenario with a large amount of data and a high speed, the storage module is capable of being switched between the first storage mode and the second storage mode.

### CROSS-REFERENCE TO RELATED APPLICATIONS

This application is a continuation-in-part of International Application No. PCT/CN2024/085836, filed on Apr. 3, 2024, which claims priority to Chinese Patent Application No. 202310363526.5, filed on Apr. 6, 2023, the entire contents of each of which are incorporated herein by reference.

### TECHNICAL FIELD

The present disclosure relates to the field of data storage technology, and in particular, to a SOC and a method for data storage thereof.

### BACKGROUND

In system on chips (SOC), particularly SOCs for radar systems, data is often characterized by: being chirp-based, transmitted in bursts, intermittent, and having a high instantaneous throughput rate. The SOCs need to be designed with first-in-first-out (FIFO) memories specialized for caching such data, and reserves required memory (MEM) for the processing module (e.g., an MCU or a CPU).

Since the instantaneous throughput rate of the data is often greater than a rate of the BUS, in order to match rates at both read and write ends of the FIFO, a general processing manner is: a capacity of the FIFO needs to be designed to be able to fully cache single burst transmission data, and the MCU needs to take the data out of the FIFO and store the data in an additional memory of a same size as the burst transmission data before participating in a computation. However, this leads to following technical problems: when the amount of the single burst transmission data is large, the capacity of the FIFO needs to be designed to be able to cache the entire amount of the burst transmission data; meanwhile, a memory used to cache the amount of the burst transmission data may be enlarged, which results in a significant increase in an area of the SOC; the data needs to be transferred from the FIFO to the memory before the MCU is capable of processing, which increases the load of the BUS and reduces a data processing speed of the MCU.

Therefore, it is desired to provide a SOC and method for data storage thereof, by a storage module that is controllably and dynamically switchable between a first storage mode and a second storage mode, to solve a problem of how to reduce a bus load and increase a data processing speed without increasing the area of the SOC in a batch transmission scenario with a large amount of data and a high speed.

### SUMMARY

One or more embodiments of the present disclosure provide a SOC. The SOC includes a storage module that is controllably and dynamically switchable between a first storage mode and a second storage mode; the SOC further includes a processing module. In the first storage mode, data in the storage module is accessible by the processing module in a first-in-first-out order; and in the second storage mode, data in the storage module is addressably accessible by the processing module. Hardware and software of the SOC together build a method and process for securely dynamically switching between the two storage modes.

One or more embodiments of the present disclosure further provide a method for data storage of a system on chip (SOC). The method includes: controllably switching a storage module between a first storage mode and a second storage mode under a drive of an indication signal. In the first storage mode, data in the storage module is accessible by a processing module in a first-in-first-out order; and in the second storage mode, data in the storage module is addressably accessible by the processing module.

One or more embodiments of the present disclosure further provide a non-transitory computer-readable storage medium, the storage medium storing computer instructions. When the computer instructions are executed by a processor, a method for data storage of a system on chip (SOC) described in any of the embodiments of the present disclosure is implemented.

Beneficial effects of embodiments of the present disclosure include, but are not limited to:

According to the SOC and the method for data storage thereof of the embodiments of the present disclosure, the storage module of the SOC is capable of being switched between the first storage mode and the second storage mode under the drive of the indication signal, expanding a data access manner of the processing module to the storage module, which allows the processing module to directly process data in a memory of the storage module in the first storage mode, thereby eliminating a need for additional memory for caching the data, and at the same time eliminating a conventional time of copying all data stored in the FIFO to the memory, reducing a bus load, and increasing a data processing speed of the processing module; at the same time, an area of the chip can be saved.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic diagram illustrating a structure of a SOC according to some embodiments of the present disclosure;

FIG. 2 is a schematic diagram illustrating a structure of a storage module according to some embodiments of the present disclosure;

FIG. 3 is an exemplary flowchart illustrating a process for switching a storage module from a first storage mode to a second storage mode according to some embodiments of the present disclosure; and

FIG. 4 is an exemplary flowchart illustrating a process for switching a storage module from a second storage mode to a first storage mode according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system,” “device,” “unit” and/or “module” used herein are a way to distinguish between different components, elements, parts, sections, or assemblies at different levels. However, the terms may be replaced by other expressions if other words accomplish the same purpose.

As shown in the present disclosure and in the claims, unless the context clearly suggests an exception, the words “one,” “a,” “an,” “one kind,” and/or “the” do not refer specifically to the singular, but may also include the plural. Generally, the terms “including” and “comprising” suggest only the inclusion of clearly identified steps and elements, however, the steps and elements that do not constitute an exclusive list, and the method or apparatus may also include other steps or elements.

Flowcharts are used in the present disclosure to illustrate the operations performed by a system according to embodiments of the present disclosure, and the related descriptions are provided to aid in a better understanding of the method and/or system. It should be appreciated that the preceding or following operations are not necessarily performed in an exact sequence. Instead, steps can be processed in reverse order or simultaneously. Also, it is possible to add other operations to these processes or to remove a step or steps from these processes.

A SOC includes a plurality of separate FIFO memories and memories, and most entities of the FIFO memories and the memories are based on a random access memory (RAM). The FIFO memory is used to cache data, employing a FIFO storage manner. Depending on an actual application, it may be necessary to sacrifice depth to match the speed of the read and write ends of the FIFO memory, and generally may only the first in data can be accessed first. . . . Generally, one end of the FIFO memory is connected to a data path of a function module, and the other end is connected to a bus. The memory is a memory required for the processing module (e.g., MCU/CPU) to operate, and is usually mounted on the bus.

The embodiment of present disclosure fully utilizes RAM resources of FIFO to act as a SOC memory, and achieves time-sharing multiplexing of RAM to realize that, for a batch transmission scenario with a large amount of data and a high speed, a load of BUS is reduced, a data processing speed of the processing module is improved, and at the same time, an area of a chip is saved.

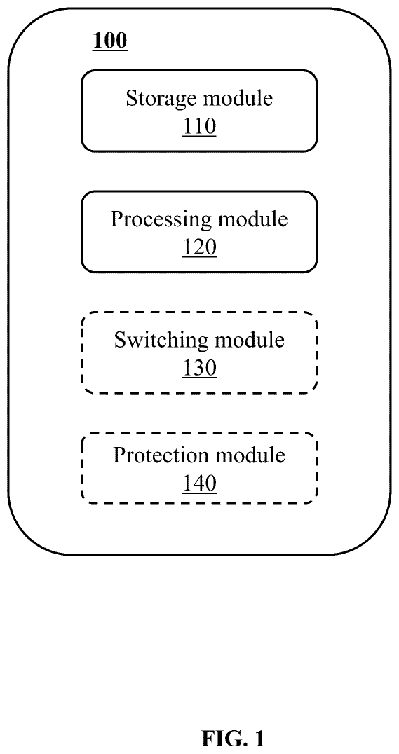

FIG. 1 is a schematic diagram illustrating a structure of a SOC according to some embodiments of the present disclosure.

In some embodiments, as shown in FIG. 1, a SOC 100 includes a storage module 110 that is controllably and dynamically switchable between a first storage mode and a second storage mode, and a processing module 120. In the first storage mode, data in the storage module 110 is accessible by the processing module 120 in a first-in-first-out order; and in the second storage mode, data in the storage module 110 is addressably accessible by the processing module 120.

The SOC refers to an integrated circuit that integrates all or most of key components (e.g., including components of computing, connectivity, control, storage management, etc.) necessary for a complete electronic system onto a single chip.

In some embodiments, the storage module 110 may be implemented via a FIFO memory and a memory. In some embodiments, the storage module 110 may also be implemented via a RAM.

In some embodiments, the storage module 110 may be controllably and dynamically switchable between the first storage mode and the second storage mode.

In some embodiments, the first storage mode is a first-in-first-out (FIFO) storage mode, and the second storage mode is a memory storage mode. A capacity of the storage module 110 (e.g., RAM) may be matched to a storage requirement when the storage module 110 is in the first storage mode. For example, the storage module with a capacity closest to an actual storage requirement is selected to avoid wasted resources (i.e., overcapacity) or a system failure (i.e., undercapacity) under a condition of meeting performance and functional requirements.

Taking the storage module 110 being a RAM as an example, in the first storage mode, the RAM may be designed with internal logic in a form of a basic FIFO memory to implement a FIFO function, maintain read/write control, read/write enablement, empty/full flags, or the like. For example, a contiguous area of standard RAM storage is utilized and made to exhibit FIFO queuing behavior at a software or system level by adding additional control logic (a read and write address, a status signal, etc.).

Merely by way of example, if a write pointer (wptr) and a read pointer (rptr) are maintained, and a FIFO writes a piece of data wptr=wptr+1, the FIFO reads a piece of data rptr=rptr+1, a difference between the two pieces of data may be used to determine whether the FIFO is empty (wptr=rptr) or full (wptr−rptr=FIFO depth), or the like. If it is an asynchronous FIFO, ptr needs to be synchronized across a clock domain.

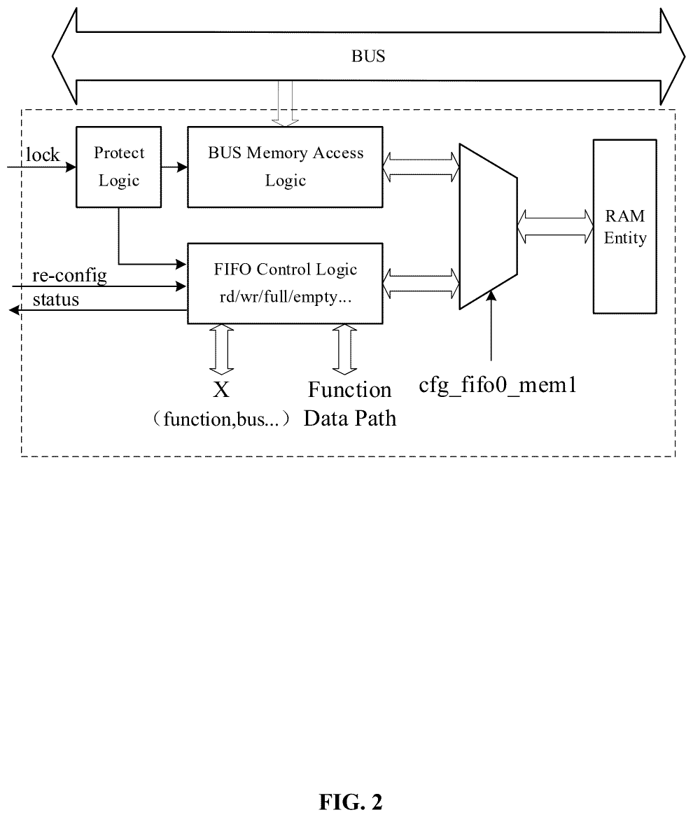

In some embodiments, in the second storage mode, the RAM may communicate directly with the bus, have an allocated address interval, and may be made to be a memory area for the processing module (e.g., MCU/CPU). More descriptions regarding the RAM and bus may be found in FIG. 2 and related descriptions thereof.

In some embodiments, the processing module 120 may be implemented via a processor.

The processor may process data and/or information obtained from other devices or system components. The processor may execute program instructions based on such data, information, and/or processing results to perform one or more of the functions described herein. In some embodiments, the processor may include one or more sub-processing devices (e.g., a single-core processing device or a multi-core processing device). Merely by way of example, the processor may include a microcontrol unit (MCU), a central processing unit (CPU), a controller, a microprocessor, or the like, or any combination thereof. In some embodiments, the processor may include a plurality of modules, and different modules may be used to execute separate program instructions.

In some embodiments, in the first storage mode, data in storage module 110 is accessible by the processing module 120 in a FIFO order; in the second storage mode, data in storage module 110 is addressably accessible by the processing module 120.

The addressably means a unique and directly locatable address of the data in the storage module.

In some embodiments, the SOC 100 may also include a switching module 130.

In some embodiments, the switching module 130 is configured to control the storage module 110 to switch between the first storage mode and the second storage mode under a drive of an indication signal.

The indication signal refers to a signal that indicates the switching module 130 to control the storage module 110. In some embodiments, the indication signal may include an interrupt signal, a status flag, or the like.

The indication signal may be sent from other modules of the SOC to the processing module 120 or the switching module 130 when switching of the storage mode is required.

In some embodiments, the indication signal may be generated by other modules of the SOC (e.g., the processing module 120 or functional modules in the SOC used to perform certain functions) or by the FIFO. The indication signal may be used by the processing module 120 to confirm whether the storage module 110 is to be switched into the first storage mode or the second storage mode.

In some embodiments, the processing module 120 may generate a first indication signal or a second indication signal based on the indication signal. The first indication signal is configured to indicate the switching module 130 to control the storage module 110 to switch from the first storage mode to the second storage mode. The second indication signal is configured to indicate the switching module 130 to control the storage module 110 to switch from the second storage mode to the first storage mode. For example, when the status flag indicates that the storage module 110 is currently in the first storage mode and the interrupt signal is that an interrupt is required, the processing module 120 may generate and send the first indication signal to indicate that the storage module 110 is to be switched from the first storage mode to the second storage mode; when the status flag signal indicates that the storage module 110 is currently in the second storage mode and the interrupt signal is that the interrupt is required, the processing module 120 may generate and send the second indication signal to indicate that the storage module 110 is to be switched from the second storage mode to the first storage mode.

In some embodiments, the processing module 120 may generate the indication signal based on a demand or an operational state of the SOC 100. Merely by way of example, when the SOC 100 is performing data acquisition, the storage module 110 needs to be in the first storage mode, and if the storage module 110 is currently in the second storage mode, the processing module 120 may generate the second indication signal; when the SOC 100 is performing data processing, the storage module 110 needs to be in the second storage mode, and if the storage module 110 is currently in the first storage mode, the processing module 120 may generate the first indication signal. Take a radar system as an example, if a desired mode (e.g., an acquisition or processing mode) for the radar system is controlled by a mode generation module in the radar system, the indication signal may also be generated correspondingly by the mode generation module and sent to the processing module 120.

In some embodiments, the processing module 120 may also receive the indication signal generated and sent by other functional modules, process the indication signal, and further indicate the switching module 130 to control the storage module 110, e.g., generate the first indication signal or the second indication signal.

In some embodiments, during an actual operation, switching between the first storage mode and the second storage mode may be performed by a control signal. The control signal refers to a signal sent from the switching module 130 that directly controls the storage module 110. Differently, the indication signal is sent from other modules to the switching module 130, and the control signal is sent from the switching module 130 to the storage module 110. For example, the switching module 130 may perform switching between the first storage mode and the second storage mode by inputting the control signal (e.g., cfg_fifo0_mem1) via a control interface. The control interface refers to an interface in the SOC for controlling the storage module 110.

In some embodiments, the switching module 130 may be implemented through a structure such as a configuration register, a finite state machine, a microcode controller, or the like.

In some embodiments, the SOC 100 may also include a protection module 140.

In some embodiments, the protection module 140 may be configured to protect stored content and access interfaces of the first storage mode and the second storage mode during switching between the first storage mode and the second storage mode to achieve a safe and stable switching.

The access interface refers to an interface in the SOC for accessing the storage module 110.

In some embodiments, the protection module 140 may be implemented by a protection circuit. In some embodiments, the protection circuit may consist of a finite state machine, a register bank, and some combinatorial logic. In some embodiments, the processing module 120 may control the protection module 140 to perform protection.

In some embodiments, the protection module 140 may input a lock signal via the control interface to lock the storage module 110. For example, under a control of the lock signal, the storage module 110 may be locked in the first storage mode, or released in the first storage mode.

The lock signal refers to a signal that controls the storage module 110 to be locked or released. For example, the lock signal may be lock, lockwr, or lockrd. The stored content and the access interfaces may be protected by the lock signal in combination with the protection module 140.

In some embodiments, the lock signal may include a first signal and a second signal, the first signal may be configured to control the storage module 110 to be locked in the first storage mode, and the second signal may be configured to control the storage module 110 to be released in the first storage mode. For example, the first signal may be at a high level and the second signal may be at a low level.

When the storage module 110 is locked in the first storage mode, the storage module 110 enters a protected state. In the protected state, the stored content of the storage module 110 is typically fixed and is not capable of being written or modified normally to ensure data security.

When the storage module 110 is released in the first storage mode, the storage module 110 exits the protected state described above and returns to a normal operating mode. In the normal operating mode, data is capable of being read, written, or modified.

In some embodiments, the switching module 130 and the protection module 140 may also be part of the storage module 110.

FIG. 2 is a schematic diagram illustrating a structure of a storage module according to some embodiments of the present disclosure.

In some embodiments, as shown in FIG. 2, the storage module may include a storage body (e.g., a RAM entity), a FIFO control logic, a protection logic, a BUS memory access logic, and the storage module communicates with a bus through the BUS memory access logic.

The protection logic may be implemented by a protection module (e.g., a protection circuit), the FIFO control logic may be implemented by a switching module, the storage body may be implemented by a RAM, and the BUS memory access logic (i.e., an access interface) may be implemented by logic circuits that are jointly composed of one or more of an arbiter, a decoder, a state machine, and a buffer, or the like.

As shown in FIG. 2, the storage module is connected to the bus. In the first storage mode, accesses to the bus are either pending or in error. In the second storage mode, a full flag and an empty flag of the storage module are both set, for example, set to 1 or 0.

It should be understood that the SOC and the modules thereof as shown in FIG. 1 may be realized in various ways.

It should be noted that the above descriptions of the SOC and the modules thereof are provided for the purposes of illustration, and are not intended to limit the scope of the present disclosure. It is understood that for persons skilled in the art, after understanding the principle of the system, it may be possible to arbitrarily combine individual modules or form a subsystem to connect with other modules without deviating from this principle. In some embodiments, the storage module 110, the processing module 120, the switching module 130, and the protection module 140 disclosed in FIG. 1 may be different modules in a single system, or may be a single module that implements the functions of two or more of the aforementioned modules. For example, the individual modules may share a common storage module, and the individual modules may each have their own storage module. Morphisms such as these are within the scope of protection of the present disclosure.

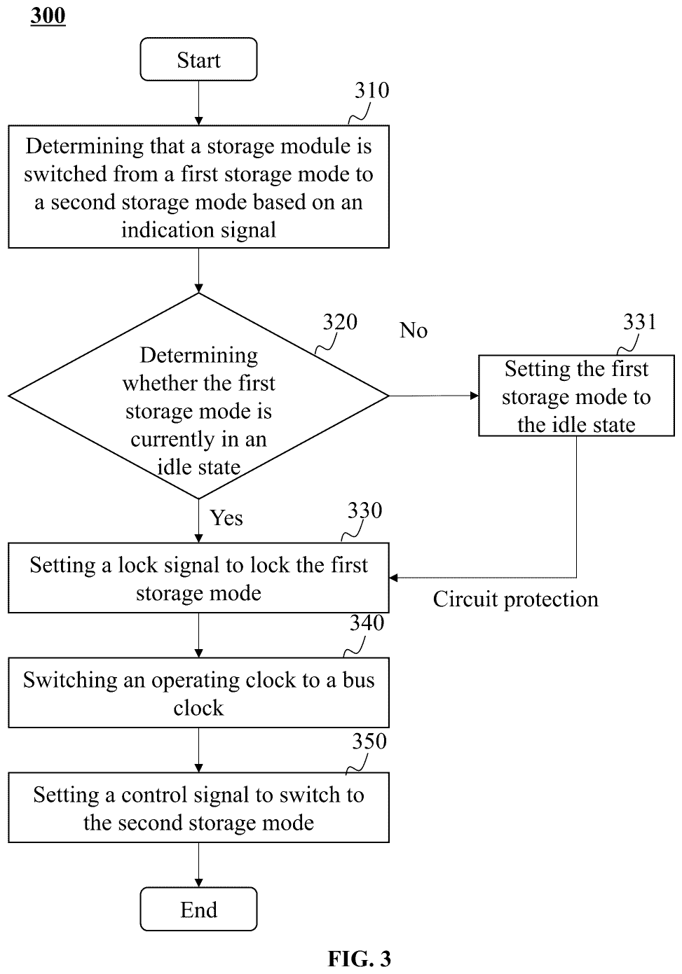

FIG. 3 is an exemplary flowchart illustrating a process for switching a storage module from a first storage mode to a second storage mode according to some embodiments of the present disclosure. As shown in FIG. 3, process 300 includes the following operations. In some embodiments, the process 300 may be performed by the SOC 100 and modules thereof.

In 310, it is determined that the storage module is switched from the first storage mode to the second storage mode based on an indication signal. In some embodiments, operation 310 may be performed by the processing module 120.

More descriptions regarding the indication signal, the storage module, the first storage mode, and the second storage mode may be found in FIGS. 1-2 and related descriptions thereof.

In some embodiments, the processing module 130 may receive the indication signal and generate a first indication signal or a second indication signal. In response to determining that the first indication signal is generated, subsequent operations in the process 300 may be performed. At this time, the storage module is in the first storage mode.

In 320, whether the first storage mode is currently in an idle state is determined. In some embodiments, operation 320 may be performed by the processing module 120.

When the storage module is switched from the first storage mode to the second storage mode, the processing module 120 may determine whether the storage module (which is in the first storage mode) is currently in the idle state.

The idle state refers to a no-access, data-holding, fast-wake-up operation mode of the storage module. In the idle state, the storage module may maintain the integrity of the system state without read or write operations and may be woken up at any time to continue working.

In some embodiments, the processing module 120 may determine whether the storage module is in the idle state by a state machine built into the storage module.

In some embodiments, determining whether or not the storage module is in the idle state depends not only on a current state of the storage module, but also on an operation of the SOC. The processing module 120 may predetermine whether the storage module maintains the idle state based on the operation of the SOC to support a switching completion of the storage mode. For example, if the SOC does not operate for a certain time period in the future (e.g., which may be determined based on a time required for switching of the storage mode), it may be determined that the storage module may maintain the idle state, and conversely, it may not maintain the idle state.

In 330, in response to determining that the first storage mode is currently in the idle state, a lock signal is set to lock the first storage mode. In some embodiments, operation 330 may be performed by the processing module 120 and/or the protection module 140.

More descriptions regarding the lock signal may be found in FIGS. 1-2 and related descriptions thereof.

When the first storage mode is currently in the idle state, the protection module 140 may provide circuit protection for subsequent switching of the storage mode. The processing module 120 may control the protection module 140 to perform protection.

In 331, in response to determining that the first storage mode is not currently in the idle state, the first storage mode is set to the idle state. In some embodiments, operation 331 may be performed by the processing module 120.

For example, the storage module may be set in the idle state by controlling pin signals of the storage module.

In order to achieve the circuit protection, the protection module 140 may continue to perform operation 330 when the first storage mode is in the idle state.

In some embodiments, in response to determining that the first storage mode is currently in the idle state, the storage module is further configured to: set a read and write address of the storage module based on a set addressing instruction; the first storage mode enters the idle state after a data flow path is completed, or enters the idle state under a control of a lock signal.

The read and write address refers to a next location to which data is to be written or read when a read operation or a write operation occurs. The read and write address may also be understood as an access address.

The addressing instruction refers to a set of pre-defined control signals used to initialize a start position of the read and write address.

In some embodiments, the read and write address of the storage module (e.g., RAM) in the first storage mode may be set based on the addressing instruction set by a user, and an operating state (information such as read and write address) of the storage module is visible to the processing module (MCU/CPU).

It should be noted that, in the first storage mode, the read and write address is implemented as a read and write pointer.

In 340, an operating clock is switched to a bus clock. In some embodiments, operation 340 may be performed by the processing module 120 and/or the switching module 130.

The bus clock refers to a clock signal that synchronizes major interconnect buses within the SOC and low-speed peripherals connected to the buses. For example, the bus clock may be bus_clk.

When the operation 330 is performed, the processing module 120 may switch the operating clock to the bus clock in order to adapt operating clocks in different storage modes (the first storage mode or the second storage mode) to reduce asynchronous processing and increase an operating rate.

In 350, a control signal is set to switch to the second storage mode. In some embodiments, operation 350 may be performed by the switching module 130.

More descriptions regarding the control signal may be found in FIGS. 1-2 and related descriptions thereof.

In some embodiments, the switching module 130 may issue the control signal via a control interface based on the indication signal. The storage module 110 may switch the storage mode based on the control signal, e.g., from the first storage mode to the second storage mode. The control signal may include cfg_fifo0_mem1.

In some embodiments, the storage module (e.g., RAM) operates in the second storage mode when the switching is complete. At this time, in the second storage mode, the storage module may set the read and write address (i.e., the access address) of the storage module according to the set addressing instruction, and no longer reads or writes data in a first-in-first-out manner.

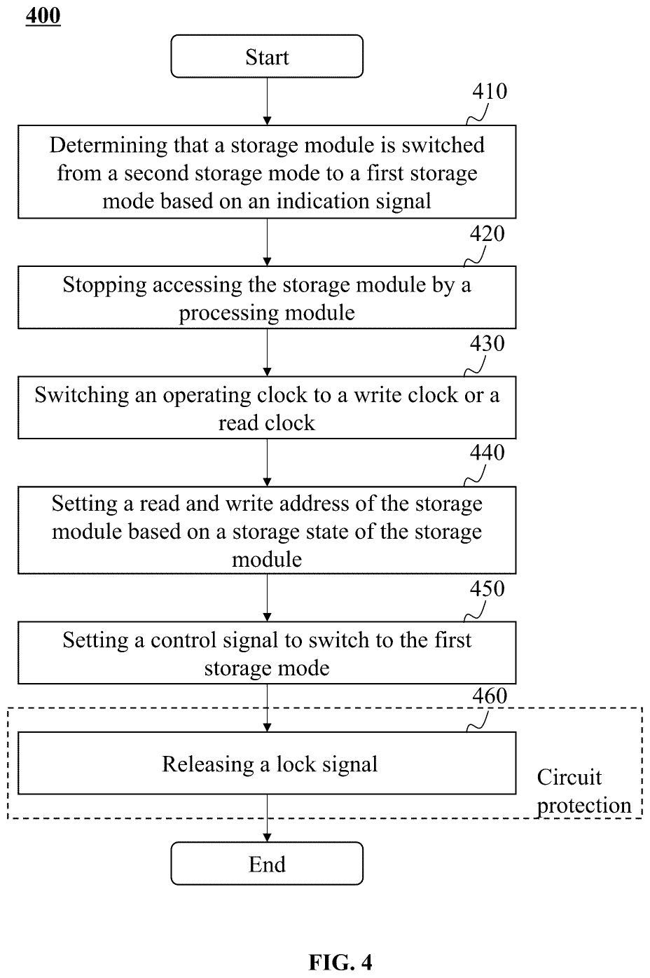

FIG. 4 is an exemplary flowchart illustrating a process for switching a storage module from a second storage mode to a first storage mode according to some embodiments of the present disclosure. As shown in FIG. 4, process 400 includes the following operations. In some embodiments, the process 400 may be performed by the SOC 100 and modules thereof.

In 410, it is determined that the storage module is switched from the second storage mode to the first storage mode based on an indication signal. In some embodiments, operation 410 may be performed by the processing module 120.

More descriptions regarding the indication signal, the storage module, the first storage mode, and the second storage mode may be found in FIGS. 1-2 and related descriptions thereof.

In some embodiments, the processing module 120 may receive the indication signal and generate a first indication signal or a second indication signal. In response to determining that the second indication signal is generated, subsequent operations in the process 400 may be performed. At this time, the storage module is in the second storage mode.

In 420, the processing module stops accessing the storage module. In some embodiments, step 420 may be performed by the processing module 120.

At this time, stopping access the storage module is done to implement a software protection that prevents the processing module from accessing the storage module during switching.

In 430, an operating clock is switched to a write clock or a read clock. In some embodiments, operation 430 may be performed by the processing module 120.

The write clock refers to a reference clock that data write operation follows. The read clock refers to a reference clock that data read operation follows. For example, the write clock may be wr_clk and the read clock may be rd_clk.

If the operating clocks in two storage modes (i.e., the first storage mode and the second storage mode) are different, a switching process needs to be realized non-glitch.

Therefore, when the operation 430 is performed, in preparation for subsequent switching, the storage module 110 may switch the operating clock to either the write clock or the read clock to ensure that the operating clocks in the two storage modes are the same.

In 440, a read and write address of the storage module is set based on a storage state of the storage module. In some embodiments, operation 440 may be performed by the processing module 120.

More descriptions regarding the read and write address may be found in FIGS. 1-3 and related descriptions thereof.

In some embodiments, the read and write address of the storage module may be set based on the storage state and an access requirement of the storage module when the storage module is switched from the second storage mode to the first storage mode.

The access requirement refers to an attribute and a requirement of a data transmission request initiated to the storage module. In some embodiments, the access requirement may include an access type, an access address, a data size, a timing requirement, or the like.

In some embodiments, the storage state may include whether a storage of the storage module is empty.

In some embodiments, when the storage module is switched from the second storage mode to the first storage mode, whether the second storage mode is in an idle state is determined.

More descriptions regarding the idle state may be found in FIGS. 1-3 and related descriptions thereof.

In some embodiments, the storage module may determine whether the storage module is in the idle state by a state machine built into the storage module.

In some embodiments, in response to determining that the second storage mode is in the idle state, a protection module is controlled to take effect to protect stored content and a storage mode interface; and the storage state of the storage module is determined.

More descriptions regarding the protection module may be found in FIGS. 1-3 and related descriptions thereof.

For example, the protection module may input a lock signal through a control interface to lock the storage module 110.

In some embodiments, the storage module may compare a “data write location” and a “data read location”, and if the two locations are equal, it indicates that all written data has been read and the storage is empty; if the two locations are not equal, the storage is not empty.

In some embodiments, in response to determining that the storage of the storage module is empty, the read and write address of the storage module is set to zero; and/or, in response to determining that the storage of the storage module is not empty, a start address and an end address of data in the storage module is obtained to set the read and write address of the storage module.

Setting the read and write address of the storage module to zero resets the read and write address to an initial address of a storage space in preparation for a brand-new data write next time, i.e., an initialization process of the storage module.

When data still exists in the storage module (e.g., the SOC wakes up from a sleep mode and needs to be restored after the switching), instead of simply resetting pointers, a boundary (including the start address and the end address) of the existing data may be calculated first, and then the read and write address may be set correctly based on the start address and the end address, so as to be able to seamlessly continue a last unfinished data flow operation.

In 450, a control signal is set to switch to the first storage mode. In some embodiments, operation 450 may be performed by the switching module 130.

More descriptions regarding the control signal may be found in FIGS. 1-2 and related descriptions thereof.

In some embodiments, the switching module 130 may issue the control signal via the control interface based on the indication signal. The storage module 110 may switch the storage mode according to the control signal, for example, from the second storage mode to the first storage mode. The control signal may include cfg_fifo0_mem1.

In 460, the lock signal is released. In some embodiments, operation 460 may be performed by the protection module 140.

More descriptions regarding the lock signal may be found in FIGS. 1-2 and related descriptions thereof.

When the switching is completed, the protection module 140 may control the storage module 110 to release in the first storage mode based on the lock signal (e.g., a second signal), i.e., return to a normal operating mode.

In some embodiments, the storage module (e.g., RAM) operates in the first storage mode when the switching is completed.

In some embodiments, in a switching process from the second storage mode to the first storage mode, if the storage of the storage module is empty, the read and write address of the storage module may be set to zero; and if the storage of the storage module is not empty, the start address and the end address of data in the storage module may be obtained to reset a state of the read and write address of the storage module.

In a practical application, such as in a radar system, generally, when sending radar signals or acquiring radar signals, the storage module may work in the first storage mode; when processing received radar signals, the storage module may work in the second storage mode.

Merely by way of example, the radar system needs to collect data first, then process the collected data, and finally send out the processed data, in which the storage mode of the storage module switches as follows:

The radar system sends out radar signals first to collect the data during a sweeping process, and at this time, the storage module is working in the first storage mode, i.e., a FIFO storage mode, and the collected data are stored in the storage module in a first-collected and first-stored manner. When a control module (other functional modules in the radar system) processes the collected data, the storage module needs to be switched to the second storage mode, i.e., a memory storage mode, in order for the control module to read the data in a corresponding storage location according to demand. When the processed data is finally sent out, the storage module switches back to the first storage mode (the FIFO storage mode) again, and the control module sends out the data in a first-processed and first-read-out manner.

One or more embodiments of the present disclosure further provide a method for data storage of a SOC.

In some embodiments, the method includes: controllably switching a storage module between a first storage mode and a second storage mode under a drive of an indication signal; in the first storage mode, data in the storage module is accessible by a processing module in a first-in-first-out order; and in the second storage mode, data in the storage module is addressably accessible by the processing module.

In some embodiments, when the storage module is switched from the first storage mode to the second storage mode, the method includes: determining whether the first storage mode is currently in an idle state; in response to determining that the first storage mode is currently in the idle state, setting a read and write address of the storage module based on a set addressing instruction.

In some embodiments, when the storage module is switched from the second storage mode to the first storage mode, the method includes: in response to determining that a storage of the storage module is empty, setting the read and write address of the storage module to zero;

and/or in response to determining that the storage of the storage module is not empty, obtaining a start address and an end address of data in the storage module to set the read and write address of the storage module.

In some embodiments, the method for data storage of a SOC may include the process 300 and the process 400.

In some embodiments, during the switching of the two storage modes by the storage module, the protection module and the above-described process 300 and process 400 may ensure the security of the stored content and the access interfaces during the switching process.

In some embodiments, hardware and software of the SOC are constructed to form a complete set of storage mode switching process, including: starting switching->reporting status->circuit protection->storage mode switching->switching completion, which may be flexibly switched to adopt different storage requirements.

The starting switching may refer to the operation 310 or the operation 410, the reporting status may refer to the operation 320 or the operation 331, the circuit protection may refer to the operation 330 or the operation 420, and the storage mode switching may refer to the operation 350 or the operation 450, or the like.

It should be noted that the foregoing descriptions of processes 300 and 400 are intended to be exemplary and illustrative only and do not limit the scope of application of the present disclosure. For those skilled in the art, various corrections and changes may be made to processes 300 and 400 under the guidance of the present disclosure. However, these corrections and changes remain within the scope of the present disclosure. For example, the operations 340 and 430 may be omitted.

One or more embodiments of the present disclosure further provide a non-transitory computer-readable storage medium, the storage medium storing computer instructions. When the computer instructions are executed by a processor, a method for data storage of a SOC described in any one of the embodiments of the present disclosure is implemented.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of the present disclosure are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for description purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A system on chip (SOC), comprising: a storage module that is controllably and dynamically switchable between a first storage mode and a second storage mode; and
a processing module, wherein
in the first storage mode, data in the storage module is accessible by the processing module in a first-in-first-out order; and
in the second storage mode, data in the storage module is addressably accessible by the processing module.

2. The SOC according to claim 1, wherein the SOC further comprises a switching module, and the switching module controls the storage module to switch between the first storage mode and the second storage mode under a drive of an indication signal.

3. The SOC according to claim 2, wherein the indication signal is at least one an interrupt signal or a status flag.

4. The SOC according to claim 1, wherein the storage module is locked in the first storage mode or released from the first storage mode under a control of a lock signal.

5. The SOC according to claim 1, wherein the SOC further comprises a protection module, and the protection module is configured to protect stored content and access interfaces of the first storage mode and the second storage mode during switching between the first storage mode and the second storage mode.

6. The SOC according to claim 1, wherein the processing module is configured to:
when the storage module is switched from the first storage mode to the second storage mode, determine whether the first storage mode is currently in an idle state.

7. The SOC according to claim 6, wherein the processing module is further configured to:
in response to determining that the first storage mode is currently in the idle state,
set a read and write address of the storage module based on a set addressing instruction,
wherein the first storage mode enters the idle state after a data flow path is completed, or enters the idle state under a control of a lock signal.

8. The SOC according to claim 1, wherein the processing module is configured to:
when the storage module is switched from the second storage mode to the first storage mode, set a read and write address of the storage module based on a storage state and an access requirement of the storage module.

9. The SOC according to claim 1, wherein the processing module is configured to:
when the storage module is switched from the second storage mode to the first storage mode, determine whether the second storage mode is in an idle state.

10. The SOC according to claim 9, wherein the processing module is configured to:
in response to determining that the second storage mode is in the idle state,
control a protection module to take effect to protect stored content and a storage mode interface; and
determine a storage state of the storage module.

11. The SOC according to claim 8, wherein the processing module is configured to:
in response to determining that a storage of the storage module is empty, set a read and write address of the storage module to zero; and/or
in response to determining that the storage of the storage module is not empty, obtain a start address and an end address of data in the storage module to set the read and write address of the storage module.

12. A method for data storage of a system on chip (SOC), comprising:
controllably switching a storage module between a first storage mode and a second storage mode under a drive of an indication signal, wherein
in the first storage mode, data in the storage module is accessible by a processing module in a first-in-first-out order; and
in the second storage mode, data in the storage module is addressably accessible by the processing module.

13. The method according to claim 12, comprising:
when the storage module is switched from the first storage mode to the second storage mode, determining whether the first storage mode is currently in an idle state.

14. The method according to claim 13, comprising:
in response to determining that the first storage mode is currently in the idle state,
setting a read and write address of the storage module based on a set addressing instruction,
wherein the first storage mode enters the idle state after a data flow path is completed, or enters the idle state under a control of a lock signal.

15. The method according to claim 12, comprising:
when the storage module is switched from the second storage mode to the first storage mode, setting a read and write address of the storage module based on a storage state and an access requirement of the storage module.

16. The method according to claim 12, comprising:
when the storage module is switched from the second storage mode to the first storage mode, determining whether the second storage mode is in an idle state.

17. The method according to claim 16, further comprising:
in response to determining that the second storage mode is in the idle state,
controlling a protection module to take effect to protect stored content and a storage mode interface; and
determining a storage state of the storage module.

18. The method according to claim 15, comprising: in response to determining that a storage of the storage module is empty, setting a read and write address of the storage module to zero; and/or
in response to determining that the storage of the storage module is not empty, obtaining a start address and an end address of data in the storage module to set the read and write address of the storage module.

19. The method according to claim 12, wherein hardware and software of the SOC are constructed to form a complete storage mode switching process including: starting switching->reporting status->circuit protection->storage mode switching->switching completion.

20. A non-transitory computer-readable storage medium, wherein the storage medium stores computer instructions, when the computer instructions are executed by a processor, a method for data storage of a system on chip (SOC) is implemented, and the method includes:
controllably switching a storage module between a first storage mode and a second storage mode under a drive of an indication signal, wherein
in the first storage mode, data in the storage module is accessible by a processing module in a first-in-first-out order; and
in the second storage mode, data in the storage module is addressably accessible by the processing module.
